(19) United States
(12) Patent Application Publication
(10) Pub. No.: US 2024/0186045 A1
(43) Pub. Date: Jun. 6, 2024

(54) ANCHORING SYSTEM WITH PERMANENT MAGNETS AND OPERATING METHOD THEREFOR

(71) Applicant: S.P.D. S.P.A., Caravaggio (BG) (IT)

(72) Inventor: Giuseppe Filosa, Caravaggio (BG) (IT)

(21) Appl. No.: 18/282,568

(22) PCT Filed: Mar. 25, 2022
(86) PCT No.: PCT/IB2022/052748

§ 371 Date: Sep. 18, 2023

(30) Foreign Application Priority Data
Apr. 1, 2021 (IT) 102021000008213

(51) Int. Cl. H01F 7/04; H01F 7/02; H01F 13/00

(52) U.S. Cl. CPC H01F 7/04; H01F 7/0273; H01F 13/003; H01F 13/006

(57) ABSTRACT

An anchoring system (1) with permanent magnets comprising at least two independent magnetic sections (MM1A, MM1B, MM2, . . . , MMm), each magnetic section comprising, in proximity thereto, at least one power relay (CH1A-S, CH1B-S, CH2-S, CHM-S) for the activation of each magnetic section, a control unit (10) which is interfaced, for the activation thereof, with the said power relays (CH1A-S, CH1B-S, CH2S . . . ), and at least one power supply backbone (11)—powered by the control unit (10)—to which the said power relays (CH1A-S, CH1B-S, CH2-S, . . . , CHM-S) are connected in parallel.

### FIELD OF THE INVENTION

The present invention relates to an anchoring system with permanent magnets and to an operating method therefor.

More specifically, it relates to an anchoring system with several remotely controllable magnetic chucks, and/or comprising at least one magnetic chuck with separately controllable magnetisation zones.

### BACKGROUND ART

Anchoring systems with permanent magnet are intended to anchor ferromagnetic material in the most varied areas of use and electropermanent versions thereof can be activated and deactivated electrically.

Electropermanent magnetic systems consist of a supporting structure made of mild steel (designed to contain all the internal components), one or more polar extensions made of mild steel with various shapes and characteristics so as to render them suitable for the various needs (known as magnetic “poles”), a variable number of permanent magnets, and one or more solenoids (necessary for the activation/deactivation of the said module).

These systems are equipped with connectors or cables for the activation thereof by means of appropriate electrical control devices.

Electropermanent magnetic systems are divided into two types, namely those which work by “demagnetisation” those which work by “inversion”.

The first family comprises only systems with magnets whose state can be changed electrically, while the second family comprises systems with both magnets whose state can be changed electrically and magnets whose state cannot be changed electrically.

Indeed, all magnets can be altered electrically, but with variable energy levels depending on the type of magnet. With the energy levels typically managed by the control systems used for these applications, it is possible to electrically modify the magnetisation state of materials such as alnico (an alloy consisting of aluminium, nickel, and cobalt), while it is not possible to significantly alter the magnetisation state of magnets such as neodymium.

For this reason, in the present document, materials such as neodymium are permanent magnets, while materials such as alnico are materials whose magnetic state is electrically modifiable by means of stress applied by solenoids with a current flowing therethrough in which the said material is embedded or with which the said material is coupled.

For both families of Electropermanent systems, the current flowing through the solenoids, according to appropriate strategies, allows the magnetic force to be activated or deactivated and, consequently, to anchor or release any piece to be clamped. Obviously, the said “suitable strategies” are linked to the electropermanent magnet family and are known to a person skilled in the art.

For example, an inversion magnetic circuit is designed to algebraically balance the flow produced by permanent magnets (neodymium) with that of electrically modifiable magnets (alnico). The algebraic sum of the two flows has a resultant in the magnetic pole, i.e., the polar extension piece located in contact with any piece to be anchored.

Typically, the flow produced by the alnico magnet is equal to the flow produced by the neodymium. If the flows are concordant, they will be summed together and will flow through the poles anchoring the material located thereabove. If the flows are discordant, being equal in absolute value, their sum will be zero. This will result in the piece located above the poles being released.

Based on the foregoing, the inversion of one of the two flows makes the anchoring surface neutral, and this flow inversion is achieved electrically.

In the case of an alnico-type magnet located inside a solenoid with the magnetisation axis parallel to the axis of the said solenoid, if the current flowing through the solenoid is right-flowing, the magnet will magnetise along the axis of the magnet with the appropriate direction, while if it is left-flowing, the magnet will magnetise in the opposite direction.

In general, there is a current value (or threshold) that ensures the whole magnet is magnetised. This current is known as the saturation current.

The solenoids located inside magnetic systems are designed to always ensure full magnetisation of the alnico. Partial magnetisation is achieved by reducing the value of this current.

From what we have seen, it is easy to understand how the ignition (or magnetisation) operation of the magnetic module is achieved by making the current inside the solenoids located around the alnico flow in a specific direction, while the magnetic module is switched off (i.e. demagnetised) by making the current flow inside the said solenoids in the opposite direction.

Unlike the electropermanent magnetic circuit which works by inversion, the electropermanent magnetic circuit which works by demagnetisation only involves the use of the said electrically modifiable magnet, i.e. the alnico. It will therefore be necessary to magnetise the alnico to activate the magnetic module and to “demagnetise” it to deactivate the module.

The magnetisation operation is the same as in the inversion case and therefore it is achieved by running a specific current through the solenoids within which the alnico is located. Demagnetisation, on the other hand, is achieved by applying a current to the solenoids in a sequence that is decreasing in amplitude and flows in alternating directions. The parameters relating to the current sequence to be applied to the solenoids (current amplitude, duration, and direction) depend on the physical and dimensional characteristics of the said magnet.

For both technologies, however, it is true that the energy required to activate the magnetic module is proportional to the volume of the electrically modifiable magnet located therewithin.

This energy is supplied only when the magnetic module is activated/deactivated, because the permanent magnets remain in the state they are in indefinitely.

An electric machine has been described above which is characterised by a non-zero inrush current and a zero current.

The control units are electrical devices that power the solenoids located inside the magnetic modules using the voltage supplied by the electricity mains. In general, they consist of a logic section that oversees the management of all activities, one or more controlled AC/DC converters (for example, thyristor rectifiers), one or more ammeters, and control elements.

The AC/DC converters are always equal in number to the partitions in the magnetic system.

Obviously, the need to connect such partitions, or “channels” as they are normally known, to the corresponding magnetic modules requires the same number of power cables as there are channels. And this is the case both when there are several activation channels belonging to a single magnetic chuck and when there are several independent magnetic chucks.

From the foregoing, it is easy to deduce that the activation of a magnetic system (consisting of one or more chucks) with n channels requires an activation time of at least n times the activation time of a single channel. Beyond this, in the case of complex anchoring architectures, the number of connection cables, especially power cables, can increase considerably.

The presence of an ammeter in the control unit allows correct magnetisation to be certified. Note that, since the system is almost always voltage-controlled, the value of this current varies from time to time according to the number of solenoids installed and the physical parameters thereof.

Therefore, in order to validate activation of the magnet, it will be necessary to customise the current control, storing the reference current values for each channel in the logic section of the control unit.

The fact that there are so many different kinds of magnetic systems is currently countered by the development of appropriate ‘custom’ multi-channel control units which are essentially programmed with the parameters of each channel which must be controlled by the aforesaid units.

Furthermore, also the electrical topology of the system (consisting of control units and several magnetic modules) becomes considerably complicated as the number thereof increases, especially, as already mentioned, with regards to the number of power cables needed to connect the respective control unit channel to the chuck or to the part of the magnetic chuck that is controlled.

### SUMMARY OF THE INVENTION

The object of the present invention is to provide an anchoring system which overcomes the technical drawbacks of the commonly known technique.

A further object of the invention is to provide a system which has a simplified electrical control topology with respect to conventional topologies.

This and other objects are achieved trough an anchoring system and an anchoring method according to the technical teaching of the annexed claims.

### BRIEF DESCRIPTION OF THE FIGURES

Further features and advantages will be more evident form the description of a preferred but not exclusive embodiment of the device, shown in a non-limiting example in the present drawings, wherein:

FIG. 1 is a view, provided as an example, of a magnetic anchoring module, which is part of the anchoring system according to the present invention;

FIG. 2 is a simplified side cut-away perspective view of a part of the module in FIG. 1;

FIG. 3 is a simplified plan view of an anchoring system according to the present invention;

FIG. 4 is a simplified diagram of the system in FIG. 3;

FIG. 5 is a simplified diagram of a possible variant of the system in FIG. 1; and

FIG. 6 shows, schematically, a cable which forms the electrical power supply backbone of the system in FIG. 3.

### DETAILED DESCRIPTION OF THE INVENTION

In the cited figures, it is shown an anchoring system indicated as a whole with reference number 1.

The permanent magnet anchoring system 1 comprises at least two independent magnetic sections MM1A, MM1B, MM2, . . . , MMm.

The magnetic sections may be independent magnetic modules MM2, MM3, therefore modules in which the magnetic chuck of the entire module is completely magnetised or demagnetised.

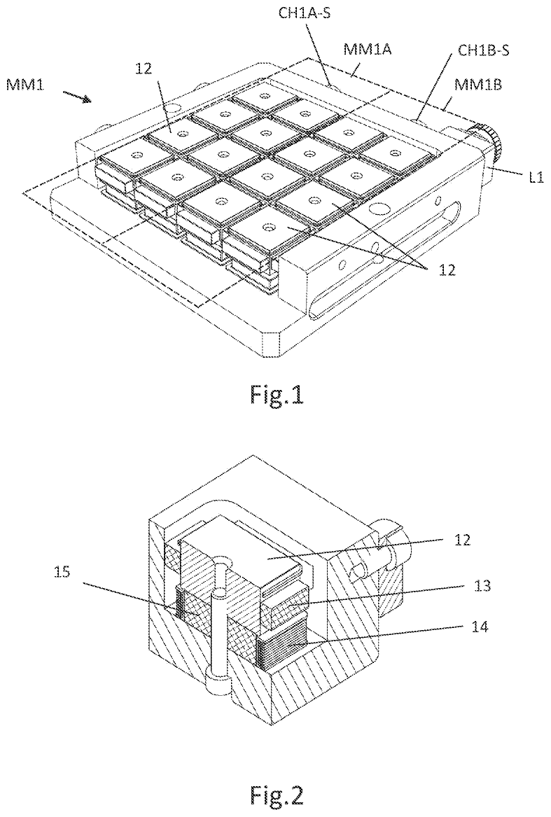

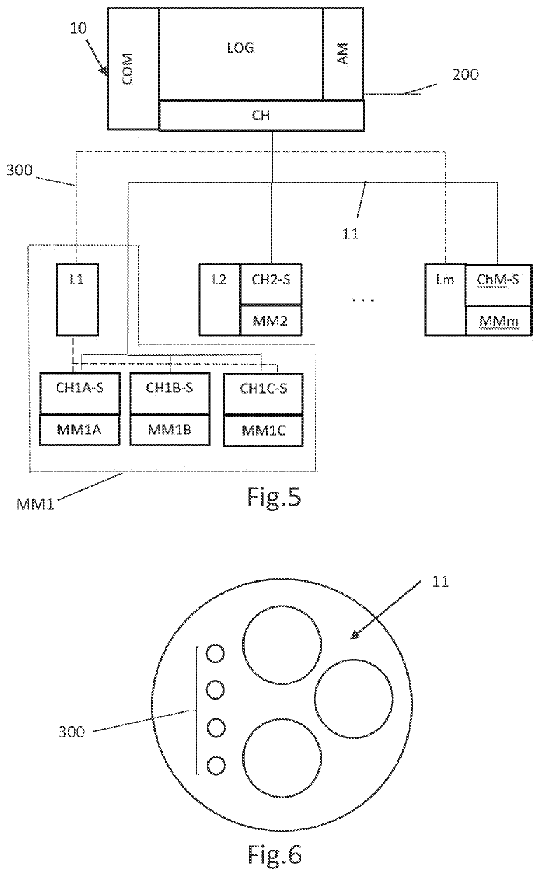

It is also possible that, as in the example in FIG. 1, a magnetic module includes more than one magnetic section (two in the case described but there may be any number; in the example in FIG. 5, there may be three). In this case the magnetic sections MM1A, MM1B are part of a single magnetic module MM1.

Essentially, the magnetic module MM1 can be magnetised or demagnetised in ‘sectors’.

The independent magnetic sections MM1A, MM1B, MM2, . . . , MMm may comprise (see FIG. 2) a plurality of ferromagnetic poles 12 associated with non-reversible magnets 13 preferably made of neodymium and with reversible magnets 15 preferably made of AlNiCo; each reversible magnet may be coupled with at least one reversing coil 14 connected, for the power supply thereto, to the said power relays.

Advantageously, all the inversion coils 14 in the same magnetic section MM1A, MM1B, MM2, . . . , MMm may be coupled to the same power relay CH1A-S, CH1B-S, CH2-S, . . . , CHM-S.

In fact, each magnetic section comprises, in proximity thereto, at least one power relay CH1A-S, CH1B-S, CH2-S, . . . , CHM-S for the operation thereof (magnetisation/demagnetisation) of each magnetic section.

In the present description, when referring to the ‘power relay’ that are in proximity of the magnetic section, it means that the power relays are very close or directly mounted on the magnetic section, far from the control unit 10.

Advantageously, all the power relays may be solid-state relays. In this document, the term relay is considered to mean any electrical, electronic, or electromechanical unit capable of electrically connecting and disconnecting the load, consisting of the solenoids in which the magnets are embedded, from the electricity mains. These devices must be suitably sized to operate at the currents and voltages envisaged. Furthermore, the choice of solid-state devices, such as thyristors, alternistors, TRIACs, etc. is preferable, but not exclusive, above all because of the almost absolute insensitivity to vibrations and a better ratio between the geometric volume and the maximum electrical parameters that can be managed. Usually, the choice goes to solid-state devices, and in particular a pair of thyristors positioned in antiparallel.

System 1, therefore, includes a control unit 10 interfaced, for the activation or deactivation thereof, with the said power relays CH1A-S, CH1B-S, CH2S, . . . . The control unit is located in a remote position, therefore away from the power relays.

There is also at least one power supply backbone 11 present, which is powered by the control unit 10. All the power relays CH1A-S, CH1B-S, CH2-S, . . . , CHM-S of the modules forming the system are connected in parallel to the backbone 11.

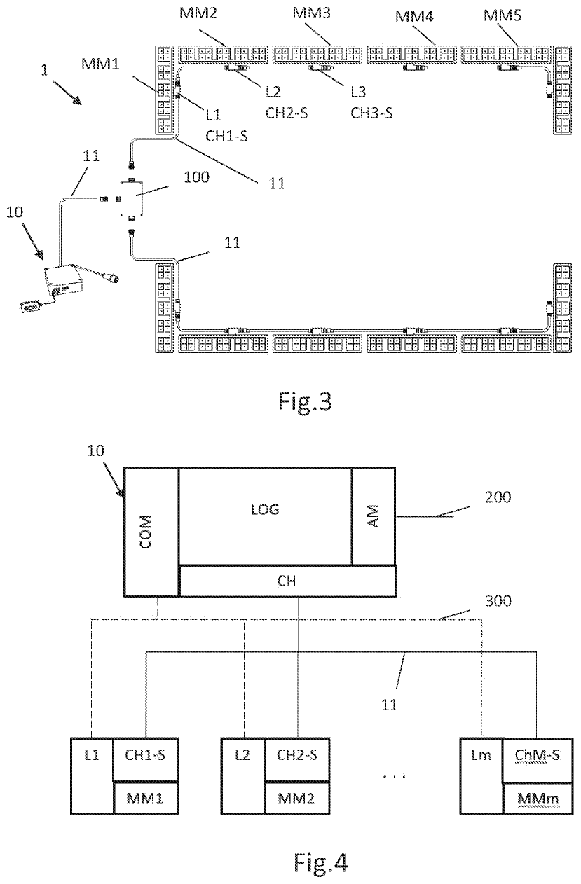

A deliberately simplified configuration of the system 1 is visible in FIG. 3, where the module MM1 is identical to the others constituting the system and is not the same as the one shown in FIG. 1.

In the example shown in FIG. 3, the backbone 11 is divided into two branches by means of a divider, which essentially keeps all the cables present in the backbone 11 positioned in parallel.

More specifically, the cables that may be present in the backbone 11 are shown schematically in FIG. 6. There are three main power cables (shown by the larger circles, which are a PE protective conductor, as well as the positive and negative conductors). Optionally, there are also cables, for example four, which form a data bus 300.

The system in FIG. 3 is simplified in the diagram in FIG. 4.

As can be seen, each magnetic module comprises a logic sub-unit L1, L2, L3, . . . , LM for controlling the power relay(s) CH1A-S, CH1B-S, CH2-S, . . . , CHM-S for the module.

Each logic sub-unit may be close (or very near) to the power relay(s) controlled by the logic sub-unit. Therefore, also each logic sub-unit L1, L2, L3, . . . , LM may me very close or directly mounted on the magnetic section (or magnetic module) controlled by the logic sub-unit.

The said logic sub-unit L1, L2, L3 may be interfaced with the control unit 10.

For example, the control unit 10 may be configured to act as a master, while each logic sub-unit L1, L2, L3 may be configured to act as a slave (in a net configuration).

Basically, the control unit 10 and the logical sub-units L1, L2, L3, . . . may be interfaced via the data bus 300 (but according to an alternative not shown, the data bus 300 may also be a wireless connection).

Advantageously, as in the cable in FIG. 6, the data bus may be integrated, and therefore coupled within the same cable, with the power supply backbone 11.

According to one aspect of the invention, each logic sub-unit L1, L2, L3, . . . , LM has at least one magnetisation or control parameter stored in the memory thereof for the magnet section or sections that it manages, and is configured to send these parameters to the control unit 10 upon request.

For example, the magnetic parameter or parameters that can be stored in the logical sub-units may be one or more of the following: magnetisation time of the relative magnetic section, possible activation angle of the AC/DC converter, average value (or peak) that the current device installed in the control unit must record in order to classify the magnetisation as validated, average current value (or peak) indicating damage to the magnetisation solenoids, etc.

In the system shown, each logical sub-unit may be accessed (via the bus 300) by the control unit by means of at least one address, preferably one address for each magnetic section it manages. The address may be a net-address.

The control unit 10 may comprise an ammeter AM, a communication interface COM for coupling to the logic sub-units, optionally an AC/DC converter and a main relay CH for supplying the power supply backbone 11, as well as a control logic LOG for the main relay CH or the AC/DC converter if there is no main relay CH.

The aforesaid converter may generate a continuously variable voltage from −V to +V depending on the activation angle α produced by the logic LOG (obviously it can also be turned off by the logic LOG).

Essentially, the control unit 10 is configured to control the main relay CH on the basis of magnetisation parameters transmitted to the control unit 10 by the logic sub-units relating to the magnetic section to be magnetised or demagnetised.

A possible example of the ‘activation’ sequence for the AC/DC converter (or the main relay CH) is described below.

The chucks are activated by applying a suitable magnetising field Hm to the alnico magnet. The term suitable means that, if the magnet is to be saturated, the field Hm to be applied must be greater than or equal to the saturation field Hs. If, on the other hand, one wishes to activate the magnet with a force value below the maximum possible, this magnetisation field value must be lower than Hs.

As regards deactivation, if the system works by inversion, it will be sufficient to apply a magnetic field Hm which is equal to −Hs, while if the system is demagnetised to achieve deactivation thereof, the alnico magnet contained in the magnetic system must be demagnetised. This operation is performed by applying a suitable sequence of magnetic fields Hm which decrease over time and alternate in direction. This means that we will apply a sequence of magnetic fields H1 . . . Hj in which it is always true that, whatever i∈[1,j]=>|Hi+1|<|Hi| and sign (Hi+1)=−sign (Hi) where j and Hj are characteristic parameters of the specific magnetic system considered. In order to obtain a suitable Hm, in terms of amplitude and sign, the current flowing through the solenoids is modulated in terms of amplitude and direction of travel by adjusting the AC/DC converter parameters. This means that the activation angle values of the AC/DC converter (or of the main relay CH) and the parameters that specify whether the current must flow through the solenoids clockwise or anticlockwise will be stored in the generic logic L in the said generic magnetic system (the AC/DC converter is such that it can generate positive or negative voltages on the basis of the alternating voltage). Other magnetisation/demagnetisation techniques may exist but these would be obvious to a person skilled in the art. Therefore, they will not be further detailed.

The system illustrated can operate according to the method described below, which includes the following steps:
a. closing at least one power relay CH1A-S, CH1B-S, CH2S . . . located in proximity to at least one independent magnetic section to be magnetised or demagnetised;
b. powering the power supply backbone 11 to which all the power relays CH1A-S, CH1B-S, CH2S, . . . are connected.

In this step, as explained, the relay for the section or magnetic module to be magnetised or demagnetised is closed, while the others are open.

Therefore, the power flowing through the backbone 11 is only absorbed by the magnetic section whose relay is closed. Electricity is supplied until the complete magnetisation/demagnetisation of at least one magnetic section.

Optionally, the current absorbed by the backbone 11 is read by the control unit 10, so as to generate a “magnetisation/demagnetisation complete” message or an error message based on the current absorbed by the backbone. The control unit 10 can also control the AC/DC converter operation (or the closing and opening of the main relay CH) based on the current flowing through the backbone 11.

For example, one can decide to switch off the power supply if the current surges (for example due to a breakage), in order to safeguard the system.

This is followed by the opening of the at least one power relay CH1A-S, CH1B-S, CH2S, . . . for the magnetised/demagnetised section which was used previously.

The steps described above are repeated until all the magnetic sections one wishes to magnetise/demagnetise have been magnetised/demagnetised.

During the system activation step, at least one logic sub-unit L1, L2, L3, . . . , LM can be read from at least one parameter relating to the magnetisation section or sections managed by the at least one said logic sub-unit.

In general, following initialisation, the control unit 10 only needs to establish the addresses of the logical sub-units present in the network.

Subsequently, in the face of a magnetisation or demagnetisation command, before activating or deactivating the specific module (or magnetic section), the control unit 10 can request the activation and verification parameters from the logic sub-unit concerned, so as to activate the section or magnetic module appropriately and validate the operation performed as correct.

The initialisation operation may be carried out by activating a set-up procedure in the logic sub-unit concerned, so that the said sub-unit can transmit its own ‘address’ (or can receive it from the control unit 10) in order to be identified.

During this step, the logic sub-unit can also transmit the parameters relating to the sections or to the magnetic module controlled thereby to the control unit 10. However, this transmission can also take place whenever it is necessary to change the magnetic state of a module or a magnetic section.

These parameters can be useful for controlling the magnetisation current, as well as for managing the supply of current (and the time evolution thereof) delivered by the control unit 10 for the correct magnetisation/demagnetisation of the section or module.

If the logic sub-unit manages more than one magnetic section MM1A, MM1B, MM2, MMm, as many addresses are obtained or assigned to the logic sub-unit as there are magnetic sections managed thereby, with the result that the control unit can control each section independently.

Obviously, the control unit 10 can also activate multiple sections or magnetic modules simultaneously, so as to reduce the system's magnetisation/demagnetisation times.

This can be done by closing multiple power relays coupled to different sections or magnetic modules. All this, assuming that the current absorbed by the backbone 11 for the operation, is within the design limits, and that the time evolution of the current in the backbone 11 (controlled by the main relay CH) is compatible with the magnetic sections or magnetic modules to be magnetised simultaneously.

FIG. 5 shows, schematically, a system wherein there are some modules with a single magnetic section, and a module (denoted MM1) with three independent magnetic sections. In this case, the logic sub-unit L1 can control the power relays for each section, even independently.

Therefore, for example, the control unit can choose to activate only the section MM1B, by ordering the logic sub-unit L1 to close the relay CH1B-S, and so on for all the other sections or for all the other modules in the system 1.

It has been shown how the system described allows a substantial simplification of the electrical topology of a system of magnetic chucks, allowing selective activation with a single control unit 10.

Indeed, it is no longer necessary—as occurs in the commonly known technique—to reach each magnetic section with dedicated power cables, each one being controlled by the control unit.

The (master) control unit 10 as described is totally independent from the specific characteristics of the magnetic module or modules connected thereto. The information required to make each magnetic section function correctly is stored in the (slave) logic unit of each magnetic module and can be transmitted to the control unit 10 asynchronously, without the need to pre-program this information into the said control unit. This is all advantageous in terms of installation flexibility.

Basically, the system may always contain at least one master control unit 10 and a plurality of slave control units (the slave control units being installed near or onto the magnetic module), a data bus 300 and a power backbone 11.

Each slave control unit may include a logic sub-unit L1, L2, L3 and at least one power relay CH1A-S that is controlled by the master control unit 10, through the logic sub-unit L1.

This slave control unit may be installed near or, better integral or aboard of the magnetic module MM1, MM2 etc.

All magnetic modules MM1, MM2, MM3 . . . share the same power backbone 11 and access it (through power relay) in a synchronized way through the information that the master control unit 10 exchanges with the slave control units via the data bus 300.

This working methodology allows to generate a multiplicity of magnetization topologies without modifying the cabling topology, but only on the basis of the controls that the master control unit 10 sends to the slave control units (logic sub-units).

Various embodiments of the innovation have been disclosed herein, but further embodiments may also be conceived using the same innovative concept.

1. An anchoring system (1) with permanent magnets comprising at least two independent magnetic sections (MM1A, MM1B, MM2, . . . , MMm), each magnetic section comprising, near it, at least one power relay (CH1A-S, CH1B-S, CH2-S, . . . , CHM-S) for the operation of each magnetic section, a control unit (10), that is located remotely from the at least one power relay (CH1A-S, CH1B-S, CH2-S, . . . , CHM-S), being interfaced for their activation with said power relays (CH1A-S, CH1B-S, CH2S, . . . ) and at least one power supply backbone (11) powered by the control unit (10) and to which said power relays are connected in parallel (CH1A-S, CH1B-S, CH2-S, . . . , CHM-S).

2. The anchoring system (1) according to claim 1, in which said magnetic sections are independent magnetic modules (MM2, MM3) and/or in which at least two magnetic sections (MM1A, MM1B) are part of a single magnetic module (MM1).

3. The anchoring system (1) according to claim 2, wherein each magnetic module comprises a logic sub-unit (L1, L2, L3, . . . , LM) for controlling the power relay or relays (CH1A-S, CH1B-S, CH2-S, . . . , CHM-S) of the module, said logic sub-unit (L1, L2, L3) being interfaced with the control unit (10) that is remotely positioned with respect to said logic sub-unit (L1, L2, L3).

4. The anchoring system (1) according to claim 3, wherein the control unit (10) and said logic sub-unit (L1, L2, L3) are part of a net where the control unit (10) is configured to act as a master while the sub-unit (L1, L2, L3) are configured to act like a slave.

5. The anchoring system according to claim 4, in which the control unit (10) and the logic sub-units (L1, L2, L3, . . . ) are interfaced via a data bus and/or via a wireless connection.

6. The anchoring system according to claim 5, in which the data bus is associated with the power supply backbone (11).

7. The anchoring system according to claim 1, wherein the independent magnetic sections (MM1A, MM1B, MM2, . . . , MMm) comprise a plurality of ferromagnetic poles (12) associated with non-reversible magnets (13), each reversible magnet being associated with at least one reversing coil (14) connected for its power supply to said power relays.

8. The anchoring system according to claim 7, in which all the inversion coils (14) of the same magnetic section (MM1A, MM1B, MM2, . . . , MMm) are associated with the same power relay (CH1A-S, CH1B-S, CH2-S, . . . , CHM-S).

9. The anchoring system according to claim 3, in which each logic sub-unit (L1, L2, L3, . . . , LM) has in memory at least one magnetization parameter relating to the magnetic section or sections it manages, and is configured to send, on request, these parameters to the control unit (10), each logic unit being accessible by the control unit through at least one address.

10. The anchoring system according to claim 1, wherein the control unit (10) comprises an ammeter (AM), a communication interface (COM) for association with the logic sub-units, an AC/DC converter or a main relay (CH) for powering the power supply backbone (11) and a logic (LOG) for controlling the relay (CH) or the AC/DC converter.

11. The anchoring system according to claim 10, wherein the control unit (10) is configured to drive the main relay (CH) and/or the AC/DC converter on the basis of at least one magnetization parameter transmitted to the control unit (10) by the logic sub-units and related to the magnetic section to be magnetized or demagnetized.

12. A method of magnetization or demagnetization of an anchoring system according to claim 1, comprising the steps of:
a. closing at least one power relay (CH1A-S, CH1B-S, CH2S . . . ) placed in proximity to at least one independent magnetic section to be magnetized or demagnetized;
b. powering the power supply backbone (11) to which all the power relays (CH1A-S, CH1B-S, CH2S, . . . ) are connected with energy up to the magnetization/demagnetization of at least one magnetic section;
c. optionally, read the current absorbed by the backbone and generate a magnetization/demagnetization or error message based on the current absorbed by the backbone;
d. open the at least one power relay (CH1A-S, CH1B-S, CH2S, . . . ) of the magnetized/demagnetized section;
e. repeat point a) until all the magnetic sections that need to be magnetized/demagnetized have been magnetized/demagnetized.

13. The method according to claim 12, in which before supplying the power supply backbone (11), at least one magnetization parameter relating to the magnetization sections managed by the at least said logic sub-unit is read.

14. The method according to claim 12, in which, preliminarily, an address is obtained or assigned to at least one logic sub-unit (L1, L2, L3, . . . , LM) which identifies it within the data bus or the wireless net, and, if the logic sub-unit manages more than one magnetic section (MM1A, MM1B, MM2, . . . , MMm), a number of addresses are obtained or assigned to the logic sub-unit, corresponding to the number of magnetic sections managed by that logic sub-unit.
